(19) United States
(12) Patent Application Publication
(10) Pub. No.: US 2016/0218424 A1
(43) Pub. Date: Jul. 28, 2016

(54) ARRAY ANTENNA DEVICE BASED ON SINGLE RF CHAIN AND IMPLEMENTATION METHOD THEREOF

(71) Applicant: Electronics and Telecommunications Research Institute, Daejeon (KR)

(72) Inventors: Yong Ho LEE, Daejeon (KR); Jung Hoon OH, Daejeon (KR); Seung Hwan LEE, Daejeon (KR); Jung Nam LEE, Daejeon (KR); Gweon Do JO, Daejeon (KR); Young Kyun CHO, Daejeon (KR)

(73) Assignee: Electronics and Telecommunications Research Institute, Daejeon (KR)

(21) Appl. No.: 14/996,634

(22) Filed: Jan. 15, 2016

(30) Foreign Application Priority Data
Jan. 27, 2015 (KR) 10-2015-0012951

(51) Int. Cl. H01Q 1/50; H01Q 21/06

(52) U.S. Cl. CPC H01Q 1/50; H01Q 21/06

(57) ABSTRACT

Disclosed are an array antenna device based on a single RF chain and an implementation method thereof. The method includes: defining a modulation technique of a data stream of to be transmitted; defining an operating frequency and an implemented antenna structure parameter based on the defined modulation technique; randomly selecting a load combination by searching all load combinations implementable with respect to parasitic elements of an array antenna; evaluating power and a phase error for a basis pattern based on the modulation technique with respect to the selected load combination; and implementing the array antenna based on one or more selected load combinations according to evaluation results of the power and phase error for all load combinations.

### CROSS-REFERENCE TO RELATED APPLICATIONS

This application claims priority to and the benefit of Korean Patent Application No. 10-2015-0012951 filed in the Korean Intellectual Property Office on Jan. 27, 2015, the entire contents of which are incorporated herein by reference.

### TECHNICAL FIELD

The present invention relates to an array antenna device based on a single RF chain and an implementation method thereof and to a technology that implements a multiplexing gain through an array antenna based on the single RF chain.

### BACKGROUND ART

Multiple-input multiple-output (MIMO) technology is a technology for increasing a channel capacity of wireless communication by using multiple antennas at transmitting and receiving terminals.

In order to increase the wireless channel capacity, since an interval between multiple antenna elements is a minimum half-wavelength or more, there is a spatial limit Since the spatial limit limits the number of antenna elements which are deployable in a limited space, it is difficult to implement the MIMO technology based on multiple antenna elements in a portable communication device and when multiple RF chains are used, power consumption increases and even effects hardware implementation cost.

Meanwhile, an array antenna based on a single RF chain performs transmission and reception by radiating one pattern formed by parasitic elements adjacent to an active element. The active element is controlled by the single RF chain and the parasitic element is controlled by a connected load value and operates by mutual coupling with the active element.

As one example, the array antenna based on the single RF chain includes an electrically steerable parasitic array radiator (ESPAR) antenna. When the ESPAR antenna is used, the multiple RF chain of the MIMO technology can be reduced, but a high design level of difficulty is required for a dynamic signal and multi-level modulation implementation.

### SUMMARY OF THE INVENTION

The present invention has been made in an effort to provide an array antenna device based on a single RF chain that can implement a multiplexing gain through an array antenna based on the single RF chain and an implementation method thereof.

An exemplary embodiment of the present invention provides an implementation method of an array antenna device based on a single RF chain, including: defining a modulation technique of a data stream to be transmitted; defining an operating frequency and an implemented antenna structure parameter based on the defined modulation technique; randomly selecting a load combination by searching all load combinations implementable with respect to parasitic elements of an array antenna; evaluating power and a phase error for a basis pattern based on the modulation technique with respect to the selected load combination; and implementing the array antenna based on one or more load combinations selected according to evaluation results of the power and phase error for all searched load combinations.

In the evaluating, it may be determined whether power between basis patterns corresponding to the load combinations is evenly allocated.

A difference in power between the basis patterns may be calculated while the operating frequency and an antenna distance are fixed.

In the evaluating, it may be determined whether a phase difference between a signal constellation of a main stream among data streams and signal constellations of substreams is within a phase error allowance range by the modulation technique.

The method may further include compensating for the phase error for the basis pattern based on the modulation technique based on the evaluation result in the evaluating.

The implementing of the array antenna may include determining whether impedance matching of an RF port is available based on the selected load combination, and the array antenna may be implemented when the impedance matching of the RF port is available. When the impedance mismatch degree of the corresponding RF port is within a predetermined allowance value of a design condition, the search may be completed without change to the load combination and the evaluating of the antenna structure.

The method may further include changing and re-searching the load combination when the power or phase error for the basis pattern based on the modulation technique is not within a reference range in the evaluating.

The method may further include changing a structure of the array antenna when the power or phase error for the basis pattern based on the modulation technique is not within a reference range with respect to all load combinations in the evaluating.

Another exemplary embodiment of the present invention provides an array antenna device based on a single RF chain, which includes one active element and multiple parasitic elements controlled by a single RF chain and operates by mutual coupling of the active element and the parasitic elements, including: a control parameter calculating unit defining an antenna structure parameter implemented based on a modulation technique of a basis pattern, and searching all load combinations implementable with respect to parasitic elements of an array antenna to evaluate power and a phase error for the basis pattern based on the modulation technique with respect to each searched load combination; an error compensating unit compensating for a phase error by a load control based on the evaluation result; an RF unit matching impedance of an RF port based on one or more load combinations selected according to evaluation results for all searched load combinations; and an antenna unit transmitting a signal through a radiation pattern based on the basis pattern by the selected load combination.

According to exemplary embodiments of the present invention, an array antenna based on a single RF chain is used to minimize power consumption and implementation cost due to an RF chain and implement a multiplexing gain through searching and controlling a load of a parasitic element.

The exemplary embodiments of the present invention are illustrative only, and various modifications, changes, substitutions, and additions may be made without departing from the technical spirit and scope of the appended claims by those skilled in the art, and it will be appreciated that the modifications and changes are included in the appended claims.

### BRIEF DESCRIPTION OF THE DRAWINGS

FIG. 1 is a diagram illustrating an array antenna device based on a single RF chain according to the present invention.

FIG. 2 is a diagram illustrating a module configuration of the array antenna device based on the single RF chain according to the present invention.

FIG. 3 is a flowchart illustrating an operating flow for an implementation method of the array antenna device based on the single RF chain according to the present invention.

FIGS. 4A to 7B are diagrams illustrating an exemplary embodiment referred for describing a load searching process of the array antenna device based on the single RF chain according to the present invention.

FIG. 8 is a diagram illustrating a computing system to which the device according to the present invention is applied.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

It is noted that technical terms used in the present invention are used to just describe a specific exemplary embodiment and do not intend to limit the present invention. Further, unless otherwise defined, the technical terms used in the present invention should be interpreted as meanings generally appreciated by those skilled in the art and should not be interpreted as excessively comprehensive meanings or excessively reduced meanings. Further, when the technical term used in the present invention is a wrong technical term that does not accurately express the spirit of the present invention, the technical term should be understood by being substituted by a technical term which can be correctly understood by those skilled in the art. In addition, a general term used in the present invention should be interpreted as defined in a dictionary or contextually, and should not be interpreted as an excessively reduced meaning.

Unless otherwise apparently specified contextually, a singular expression used in the present invention includes a plural expression. In the present invention, a term such as “comprising” or “including” should not be interpreted as necessarily including all various components or various steps disclosed in the invention, and it should be interpreted that some component or some steps among them may not be included or additional components or steps may be further included

Terms including ordinal numbers, such as ‘first’ and ‘second’, used in the present invention can be used to describe various components, but the components should not be limited by the terms. The above terminologies are used only for distinguishing one component from another component. For example, a first component may be named a second component and similarly, the second component may also be named the first component, without departing from the scope of the present invention.

Hereinafter, exemplary embodiments of the present invention will be described in detail with reference to the accompanying drawings, in which like reference numerals refer to like or similar elements regardless of reference numerals and a duplicated description thereof will be omitted.

In describing the present invention, when it is determined that the detailed description of the publicly known art related to the present invention may obscure the gist of the present invention, the detailed description thereof will be omitted. Further, it is noted that the accompanying drawings are only for easily understanding the spirit of the present invention and it should not be interpreted that the spirit of the present invention is limited by the accompanying drawings.

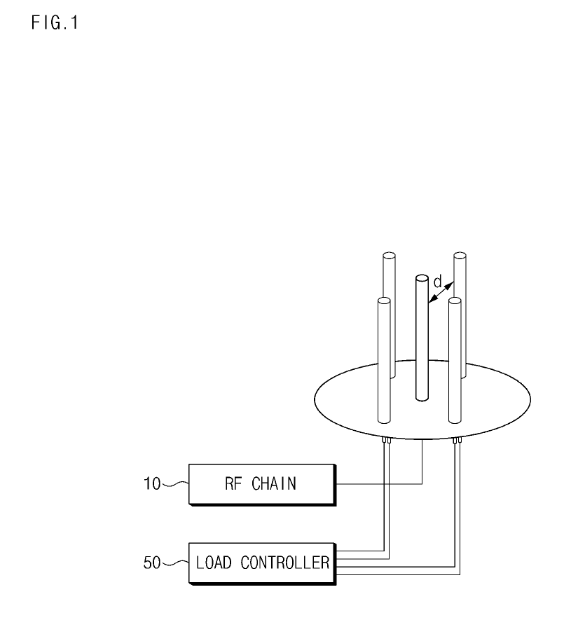

FIG. 1 is a diagram illustrating an array antenna device based on a single RF chain according to the present invention.

As illustrated in FIG. 1, an array antenna device (hereinafter, referred to as ‘array antenna device’) based on a single RF chain according to the present invention includes one active element and multiple parasitic elements and the active element and the parasitic elements operate by mutual coupling. Herein, the active element of the array antenna device is connected with a single RF chain 10 and controlled by the single RF chain 10. Further, loads are connected to the parasitic elements of the array antenna device and the load connected to each parasitic element is controlled by a load controller 50. The present invention includes a load implementation scheme such as a switch based fixed element or a variable single element or a circuit based variable element in load implementation schemes.

In this case, one pattern formed by the active element and the adjacent parasitic elements is radiated to transmit and receive a data stream. In this case, the array antenna device transmits a symbol vector corresponding to multiple data streams by using the single RF chain 10 and the load controller 50. Herein, a data stream that passes through the single RF chain 10 or becomes a criterion of other data streams is defined as a main stream and residual data streams may be defined as substreams.

An antenna array has M elements and in this case, the radiation pattern may be represented by a combination of N basis functions or patterns. Each basis function in the radiation pattern has a weighted value and may be expressed by a function having current, load resistance, or a load that flow on each of the M elements as input values.

As one example, the basis function may have an operating frequency f, an antenna distance d, each element θ or φ, loads Z₁, Z₂, . . . , Z_{M} applicable to each element, such as Bn(f, d, θ, φ, Z₁, Z₂, . . . , Z_{M}) as input parameters.

Herein, the array antenna device expresses information on the multiple data streams as a weighted value of each basis pattern to acquire a multiplexing gain based on the single RF chain 10.

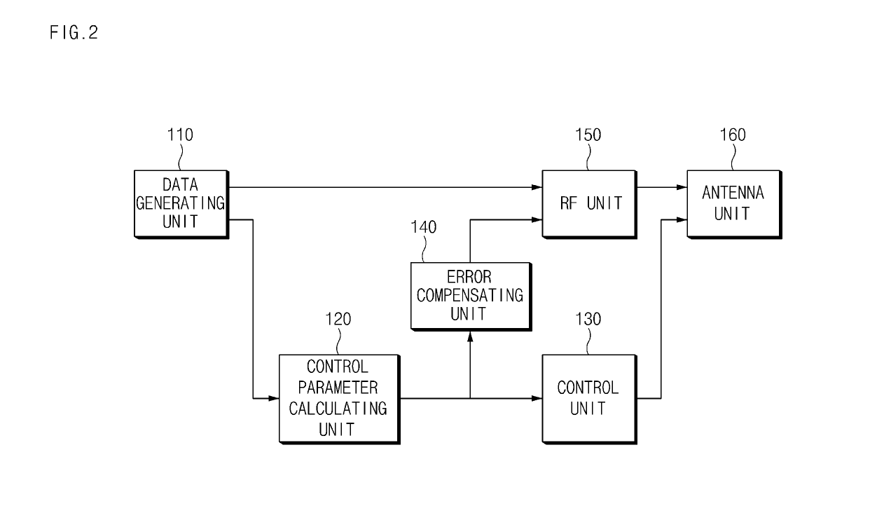

FIG. 2 is a diagram illustrating a module configuration of the array antenna device based on the single RF chain according to the present invention.

A data generating unit 110 generates a data stream to be transmitted through the array antenna device. In this case, the data generating unit 110 may define a main stream and a substream among the multiple data streams. In this case, the data generating unit 110 may transfer the generated data stream to each of an RF unit 150 and a control parameter calculating unit 120.

The control parameter calculating unit 120 may define structure parameters for designing a radiation pattern of a predetermined antenna and calculate a value of each control parameter. As one example, the operating frequency f, each element θ or φ, the loads Z₁, Z₂, . . . , Z_{M} applicable to each element, and the like, the current, the load resistance, and the like that flow on each element of the radiation pattern may correspond to the control parameter. Of course, in the control parameter calculating unit 120, the defined control parameter may vary according to a scheme that modulates an antenna structure and the data stream.

In this case, the control parameter calculating unit 120 may calculate basis pattern power and a phase error based on a selected modulation scheme and evaluate the calculated basis pattern power and phase error. Further, the control parameter calculating unit 120 of the present invention may calculate the basis pattern power and the phase error in real time and calculate the basis pattern power and the phase error in advance according to a purpose of a designer and store the calculated basis pattern power and phase error in advance to omit a function and implementation of the control parameter calculating unit 120.

The control parameter calculating unit 120 may transfer the calculated control parameter values, and an evaluation result for the basis pattern power and the phase error to a control unit 130 and an error compensating unit 140.

The error compensating unit 140 may compensate for the phase error based on the control parameter values, and the evaluation result for the basis pattern power and the phase error transferred from the control parameter calculating unit 120.

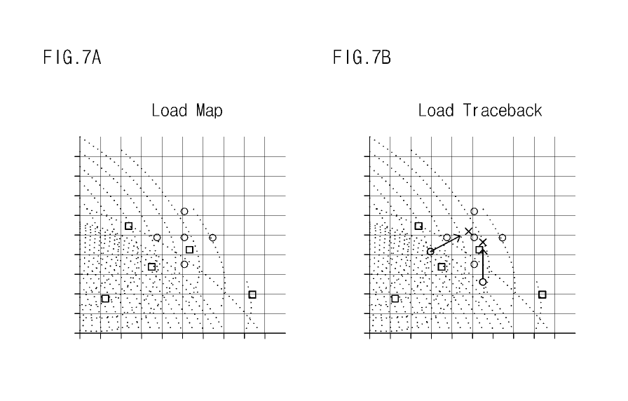

As one example, when it is assumed that a reference basis pattern for the main stream is B0,ref(φ, θ) and a basis pattern by controlling the load is B0(φ, θ), the error compensating unit 140 may compensate for an amplitude and a phase which deviate from the reference basis pattern B0,ref(φ, θ) by the basis pattern B0(φ, θ) by controlling the load inversely. Meanwhile, the error compensating unit 140 may compensate for an error distance which occurs among a searched load combination and an antenna acquired by actually implementing the searched load combination, impedance matching, and a control circuit, by using a load traceback scheme. Herein, an exemplary embodiment for an operation of compensating for an error by using the load traceback scheme will be described with reference to FIGS. 7A and 7B.

The RF unit 150 matches impedance of an RF port based on the load combination controlled by the control unit 130 and the antenna unit 160 implements a radiation pattern of a multiplexing gain antenna determined based on one or more load combinations among the searched load combinations.

In this case, the control unit 130 may control the data stream generated by the data generating unit 110 to be radiated through an antenna implemented in a multiplexing gain radiation pattern.

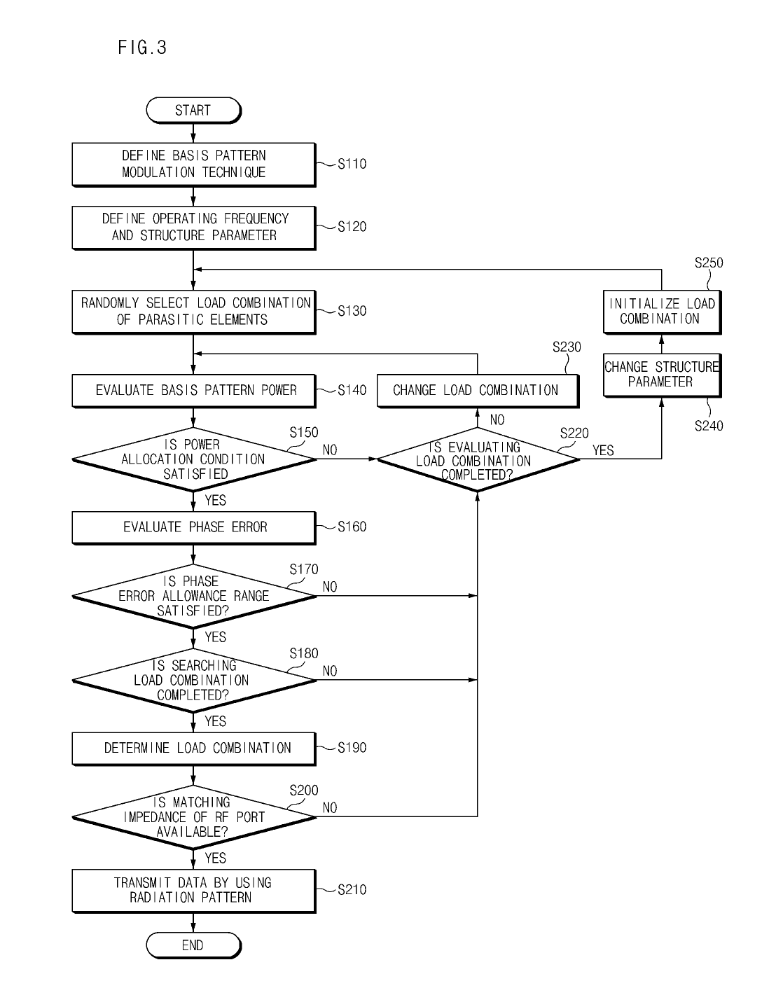

A detailed operating flow for the array antenna device according to the present invention, which is configured as above will be described in more detail with reference to an exemplary embodiment of FIG. 3.

FIG. 3 is a flowchart illustrating an operating flow for an implementation method of the array antenna device based on the single RF chain according to the present invention.

Referring to FIG. 3, the array antenna device according to the present invention defines a modulation technique of a data stream which is transmittable in order to implement a radiation pattern of an array antenna (S110). In this case, the array antenna device defines an operating frequency and an antenna structure parameter to be implemented based on the modulation technique defined during ‘S110’ (S120).

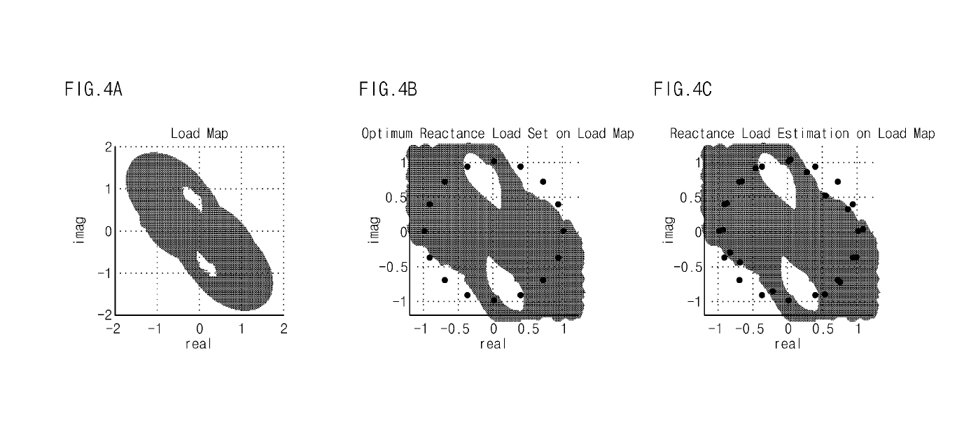

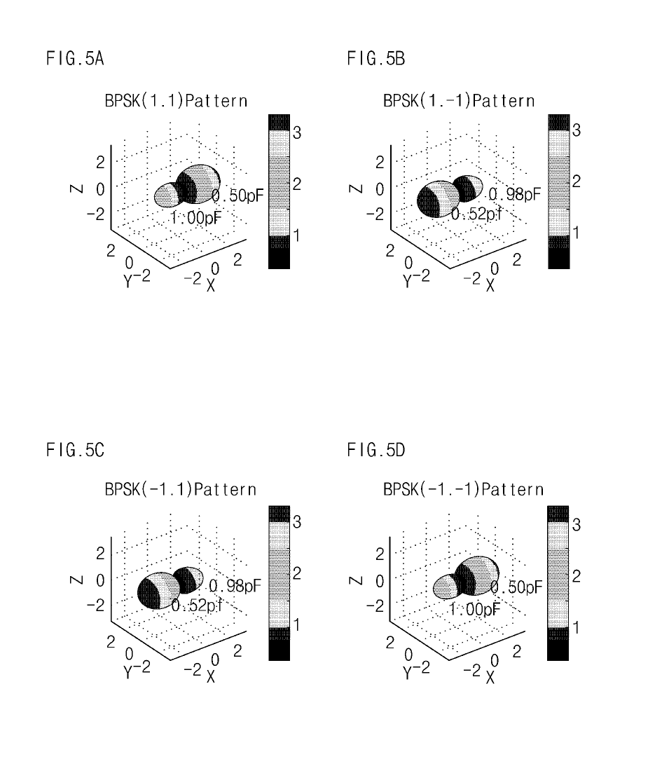

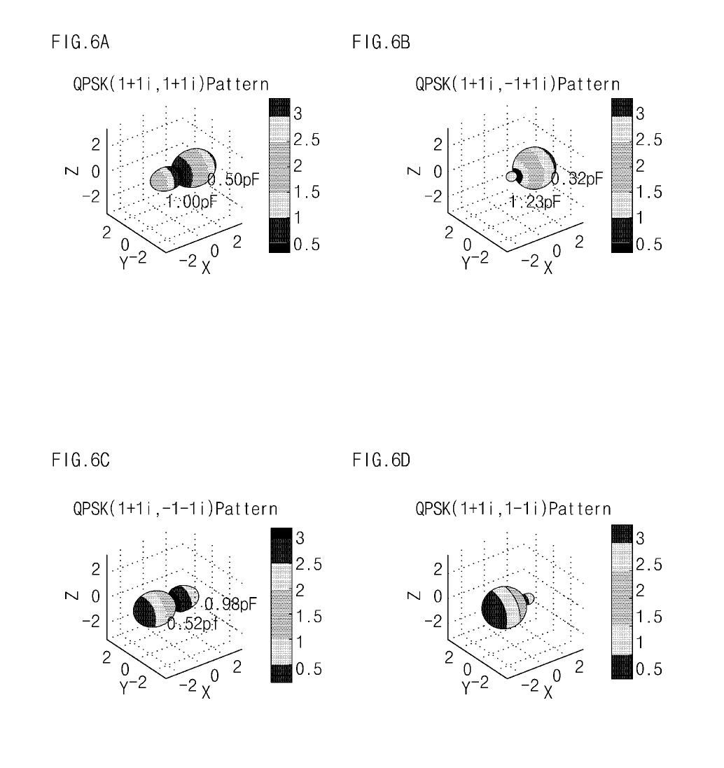

The array antenna device randomly selects a load combination in order to search a load combination of a parasitic element implementing the array antenna (S130). As one example, an operation of searching the load combination for a PSK modulation scheme may be represented as in the exemplary embodiment of FIGS. 4A to 4C, and FIGS. 5A to 6D illustrate a search simulation and a pattern simulation result according to the searched load combination by the modulation technique. Herein, FIGS. 4A to 4C illustrate a result of simulating a load search based on a 16PSK technique and FIGS. 5A to 6D illustrate a result of a pattern simulation based on the searched load combination.

In this case, when a predetermined combination for the load search is selected during ‘S130’, the array antenna device evaluates power of a basis pattern based on a modulation technique for the load combination selected during ‘S130’ (S140).

Herein, the power for the basis pattern based on the modulation technique for the load combination may be evaluated by using [Equation 1] given below.

$$[ Equation 1 ]$$

$${R}_{n} = \frac{{\int \int }_{π , 2 π} {B}_{n} ( φ , θ , {Z}_{1} , {Z}_{2} , … , {Z}_{M} ) {B}_{n}^{*} ( φ , θ , {Z}_{1} , {Z}_{2} , … , {Z}_{M} ) d φ d θ}{{\int \int }_{π , 2 π} {B}_{0} ( φ , θ , {Z}_{1} , {Z}_{2} , … , {Z}_{M} ) {B}_{0}^{*} ( φ , θ , {Z}_{1} , {Z}_{2} , … , {Z}_{M} ) d φ d θ}$$

In this case, in [Equation 1], Rn represents a power ratio, B₀( ) represents the basis pattern function for the main stream, Bn( ) represents an n-th basis pattern function, and n represents an integer which is 1≦n≦N−1. Further, θ and φ represent each element of the basis pattern and Z₁ to Z_{M} represent allocable load variables.

Herein, the array antenna device evaluates performance for the load combination by using [Equation 1] while the operating frequency f and the antenna distance d are fixed.

The array antenna device determines whether power between basis patterns is evenly or unevenly, which is similar to a power allocation scheme derivable from the modulation technique defined during ‘S110’. In this case, the array antenna device may evaluate that a power allocation condition is satisfied when the Rn value calculated in [Equation 1] is equal to or approximate to a reference value.

When the evaluation result during ‘S140’ satisfies the power allocation condition by the modulation technique defined during ‘S110’ (S150), the array antenna device evaluates the phase error based on the corresponding modulation technique (S160).

$${Δ}_{phs , n} = {f}_{δ} ( {w}_{n} \frac{{s}_{0}}{{s}_{n}} ) \qquad [ Equation 2 ]$$

In [Equation 2], Δphs, n represents the phase error, f_{δ} represents a phase calculation function, Wₙ represents a weighted value of the basis function in the basis pattern by the corresponding load combination, S₀ represents information on the main stream, Sₙ represents information on residual data streams other than the main data stream in the multiple data stream information, and n represents the integer which is 1≦n≦N−1.

The phase error represents a phase difference between a signal constellation of the main stream among the data streams and signal constellations of the substreams. Herein, the array antenna device may calculate Δphs, and n by using [Equation 2] and evaluate that a phase error allowance range is satisfied when the calculated Δphs, and n value is smaller than a reference value.

In this case, when the evaluation result during ‘S160’ satisfies the phase error allowance range by the corresponding modulation technique (S170), it is verified whether all load combinations for the multiplexing gain are searched (S180).

When all load combinations are not searched during ‘S180’, the array antenna device verifies whether evaluating all load combinations is completed and when the evaluation is not completed, the array antenna device changes the unevaluated load combinations to other load combinations (S230) and evaluates the power of the basis pattern based on the modulation technique for the load combination changed during ‘S230’ (S140). Herein, the array antenna device may repeatedly search various load combinations due to a nonlinear characteristic between the radiation pattern and the load.

Meanwhile, when evaluation of all load combinations is completed while a power evaluation result or a phase error evaluation result is not satisfactory during ‘S220’, the array antenna device changes the structure parameter of the antenna to be implemented (S240) and initializes the load combination of the parasitic elements (S250). Thereafter, the array antenna device randomly selects the load combination through ‘S130’ again.

The array antenna device even when the power evaluation result of the basis pattern does not satisfy the power allocation condition by the modulation technique during ‘S150’ or when the phase error evaluation result based on the modulation technique does not satisfy the power allocation condition by the corresponding modulation technique during ‘S170’, ‘S220’ is performed and ‘S230’ or ‘S240’ is performed according to the result.

When the load search is completed while the power evaluation result and the phase error evaluation result for one or more load combinations are satisfactory, the array antenna device determines one or more load combinations that satisfy the power evaluation result and the phase error evaluation (S190). In this case, the array antenna device selects a load combination that maximally satisfies the power evaluation and the phase error evaluation for the basis pattern based on the modulation technique, and as a result, when transmitting/receiving performance deterioration caused by a problem of power and a phase error may be reduced at the time of driving the array antenna device. Herein, the array antenna device may compensate for the phase error for the basis pattern based on the modulation technique according to the power evaluation and the phase error evaluation result for the basis pattern based on the modulation technique.

Meanwhile, the array antenna device may compensate for the error distance which occurs among the searched load combination and the antenna acquired by actually implementing the searched load combination, the impedance matching, and the control circuit, by using the load traceback scheme. An exemplary embodiment therefor will be described with reference to FIGS. 7A and 7B.

Thereafter, the array antenna device determines whether the impedance matching of the RF port is available based on the determined load combination (S200) and when the impedance matching of the RF port is not available or an impedance mismatch degree is more than an allowance value of a design condition during ‘S200’, the array antenna device performs ‘S220’ and performs ‘S230’ or ‘S240’ according to the result.

On the contrary, when it is verified that the impedance matching of the RF port is available or the mismatch degree is within the allowance value during ‘S200’, the array antenna is implemented through a radiation pattern based on a basis pattern corresponding to a finally determined load combination (S210).

Herein, the radiation pattern of the array antenna may be represented by a combination of N basis functions or basis patterns. In this case, the radiation pattern may be calculated through [Equation 3] given below.

$$P ( φ , θ ) = {\sum }_{n = 0}^{N - 1} {w}_{n} {B}_{n} ( φ , θ ) = {\sum }_{n = 0}^{N - 1} {s}_{n} {B}_{n} ( φ , θ ) \qquad [ Equation 3 ]$$

In [Equation 3], P(φ,θ) represents a radiation pattern function, Bn(φ,θ) represents the n-th basis pattern function, Wₙ represents a weighted value of the corresponding basis pattern function, Sₙ represents the multiple data stream information, and φ and θ represent each element of the basis pattern.

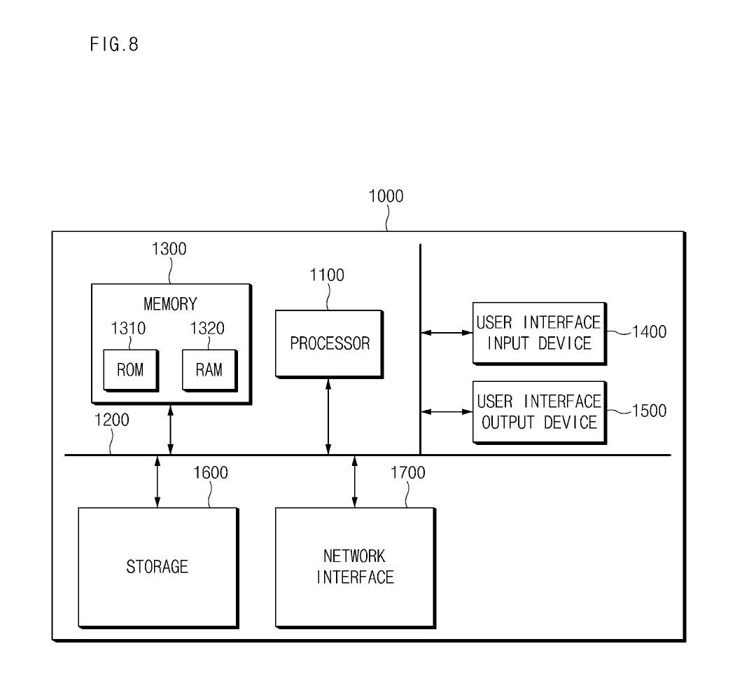

FIG. 8 is a diagram illustrating a computing system to which the device according to the present invention is applied.

Referring to FIG. 8, the computing system 1000 may include at least one processor 1100, a memory 1300, a user interface input device 1400, a user interface output device 1500, a storage 1600, and a network interface 1700 connected through a bus 1200.

The processors 1100 may be a central processing unit (CPU) or a semiconductor device that processes commands stored in the memory 1300 and/or the storage 1600. The memory 1300 and the storage 1600 may include various types of volatile or non-volatile storage media. For example, the memory 1300 may include a read only memory (ROM) and a random access memory (RAM).

Therefore, steps of a method or an algorithm described in association with the exemplary embodiments disclosed in the specification may be directly implemented by hardware and software modules executed by the processor 1100, or a combination thereof. The software module may reside in storage media (that is, the memory 1300 and/or the storage 1600) such as a RAM memory, a flash memory, a ROM memory, an EPROM memory, an EEPROM memory, a register, a hard disk, a removable disk, and a CD-ROM. The exemplary storage medium is coupled to the processor 1100 and the processor 1100 may read information from the storage medium and write the information in the storage medium. As another method, the storage medium may be integrated with the processor 1100. The processor and the storage medium may reside in an application specific integrated circuit (ASIC). The ASIC may reside in a user terminal. As yet another method, the processor and the storage medium may reside in the user terminal as individual components.

The specified matters and limited embodiments and drawings such as specific components in the present invention have been disclosed for illustrative purposes, but just provided to assist overall appreciation of the present invention and not limited thereto, and those skilled in the art will appreciate that various modifications and changes can be made, within the scope without departing from an essential characteristic of the present invention. The spirit of the present invention should not be defined while being limited to the exemplary embodiments described above and it should be appreciated that all technical spirits which are equivalent to or equivalently transformed from the appended claims in addition to the appended claims to be described beloware included in the claims of the present invention.

What is claimed is:

1. An implementation method of an array antenna device based on a single RF chain, the method comprising:
defining a modulation technique of a data stream to be transmitted;
defining an operating frequency and an implemented antenna structure parameter based on the defined modulation technique;
randomly selecting a load combination by searching all load combinations implementable with respect to parasitic elements of an array antenna;
evaluating power and a phase error for a basis pattern based on the modulation technique with respect to the selected load combination; and
implementing the array antenna based one or more selected load combinations according to evaluation results of the power and phase error for all load combinations.

2. The method of claim 1, wherein in the evaluating, the power for the basis pattern based on the modulation technique is evaluated according to a degree at which power between basis patterns corresponding to the load combinations is evenly allocated.

3. The method of claim 2, wherein a difference in power between the basis patterns is calculated while the operating frequency and an antenna distance are fixed.

4. The method of claim 1, wherein in the evaluating, it is determined whether a phase difference between a signal constellation of a main stream among data streams and signal constellations of substreams is within a phase error allowance range by the modulation technique.

5. The method of claim 1, further comprising:
compensating for the phase error for the basis pattern based on the modulation technique based on the evaluation result in the evaluating.

6. The method of claim 5, wherein in the compensating for the phase error, a phase error deviated by a load control is compensated according to a predetermined reference value.

7. The method of claim 1, wherein the implementing of the array antenna includes determining whether impedance matching of an RF port is available based on the selected load combination, and
the array antenna is implemented when the impedance matching of the RF port is available.

8. The method of claim 7, wherein the implementing of the array antenna further includes determining an impedance mismatch degree of the RF port, and
the array antenna is implemented when the impedance mismatch degree of the corresponding RF port is within a predetermined allowance value.

9. The method of claim 1, further comprising:
changing and re-searching the load combination when the power or phase error for the basis pattern based on the modulation technique is not within a reference range in the evaluating.

10. The method of claim 1, further comprising:
changing a structure of the array antenna when the power or phase error for the basis pattern based on the modulation technique is not within a reference range with respect to all load combinations in the evaluating.

11. An array antenna device based on a single RF chain, which includes one active element and multiple parasitic elements controlled by a single RF chain and operates by mutual coupling of the active element and the parasitic elements, the device comprising:
a control parameter calculating unit defining an antenna structure parameter implemented based on a modulation technique of a basis pattern, and searching all load combinations implementable with respect to parasitic elements of an array antenna to evaluate power and a phase error for the basis pattern based on the modulation technique with respect to each searched load combination;
an error compensating unit compensating for a phase error by a load control based on the evaluation result;
an RF unit matching impedance of an RF port based on one or more load combinations selected according to evaluation results for all searched load combinations; and
an antenna unit transmitting a signal through a radiation pattern based on the basis pattern by the selected load combination.
